(19) United States
(12) Patent Application Publication
(10) Pub. No.: US 2015/0100455 A1
(43) Pub. Date: Apr. 9, 2015

(54) FASHION COORDINATION ASSIST DEVICE, FASHION COORDINATION ASSIST SYSTEM, FASHION COORDINATION ASSIST METHOD, AND RECORDING MEDIUM

(71) Applicant: NEC Solution Innovators, Ltd., Tokyo (JP)

(72) Inventors: Yoshiyuki KITOU, Tokyo (JP); Sadashige MORITA, Tokyo (JP); Ryouta KAWASAKI, Tokyo (JP)

(21) Appl. No.: 14/505,666

(22) Filed: Oct. 3, 2014

(30) Foreign Application Priority Data
Oct. 3, 2013 (JP) 2013-208636

(51) Int. Cl. G06Q 30/06; G06Q 50/00; H04L 12/18

(52) U.S. Cl. CPC G06Q 30/0631; H04L 12/1813; G06Q 50/01
USPC 705/26.7

(57) ABSTRACT

Disclosed is a fashion coordination assist device etc. which provides fashion coordination automatically reflecting preference of a user.

The fashion coordination assist device including: a product information obtaining unit to obtain product information via a communication line; a coordination information providing unit to provide coordination information representing a combination of products to be worn by a user, on the basis of the product information obtained by the product information obtaining unit; a user information obtaining unit to obtain user information via the communication line; and a tendency information generating unit to estimate a fashion tendency of the user on the basis of the user information obtained by the user information obtaining unit, and generates tendency information representing a tendency of fashion of the user, wherein the coordination information providing unit provides the coordination information on the basis of user fashion tendency information generated by the tendency information generating unit.

This application is based upon and claims the benefit of priority from Japanese Patent Application No. 2013-208636, filed on Oct. 3, 2013, the disclosure of which is incorporated herein in its entirety by reference.

### TECHNICAL FIELD

The present invention relates to a fashion coordination assist device, a fashion coordination assist system, a fashion coordination assist method, and a recording medium.

### BACKGROUND ART

The prevalence of the Internet increases purchase of clothes and the like at shopping sites on the Internet. A user looks at pictures of clothes and the like at shopping sites, selects clothes the user likes, designates a size and the like, and purchases the clothes. However, while at an actual shop, a purchaser receives advice from a staff person at the shop to make a combination (coordination) of clothes, on the Internet, a user cannot receive specialist advice to make coordination of clothes. To solve this problem, Patent Literature 1 (International Publication No. 2003/069526) discloses a system that automatically advises about fashion coordination on the Internet.

According to the system of Patent Literature 1, although clothes coordination matching physical characteristics of a user can be made, coordination automatically reflecting fashion preference of a user cannot be made.

In view of above, a main object of the present invention is to provide a fashion coordination assist device and the like that can make fashion coordination reflecting fashion preference of a user.

### SUMMARY

An aspect of the present invention, a fashion coordination assist device including: a product information obtaining unit to obtain product information via a communication line; a coordination information providing unit to provide coordination information representing a combination of products to be worn by a user, on the basis of the product information obtained by the product information obtaining unit; a user information obtaining unit to obtain user information via the communication line; and a tendency information generating unit to estimate a fashion tendency of the user on the basis of the user information obtained by the user information obtaining unit, and generates tendency information representing a tendency of fashion of the user, wherein the coordination information providing unit provides the coordination information on the basis of user fashion tendency information generated by the tendency information generating unit.

An aspect of the present invention, a fashion coordination assist system including: a user terminal used by a user; and a server communicatably connected to the user terminal via a communication line, wherein the server includes the fashion coordination assist device according to claim 1, and the server transmits, via the communication line, to the user terminal, the coordination information generated by the fashion coordination assist device.

An aspect of the present invention, a fashion coordination assist method for providing coordination information of products to a user, the method including that an information processing device performs obtaining product information via a communication line; providing coordination information representing a combination of products to be worn by a user, on the basis of the obtained product information; obtaining user information via the communication line; estimating a fashion tendency of the user on the basis of the obtained user information to generate tendency information that represents a tendency of fashion of the user; and providing the coordination information on the basis of the generated tendency information at the time of providing the coordination information.

An aspect of the present invention, a non-transitory recording medium that stores a program causing a computer transmitting coordination information of products to a user terminal via a communication line, to execute: a processing to obtain product information via a communication line; a processing to provide coordination information representing a combination of products to be worn by a user, on the basis of the obtained product information; a processing to obtain user information via the communication line; a processing to estimate a fashion tendency of the user on the basis of the obtained user information to generate tendency information that represents a tendency of fashion of the user; and a processing to provide the coordination information on the basis of the generated tendency information at the process of providing the coordination information.

According to the fashion coordination assist device and the like of the present invention, it is possible to provide fashion coordination automatically reflecting preference of a user.

### BRIEF DESCRIPTION OF THE DRAWINGS

Exemplary features and advantages of the present invention will become apparent from the following detailed description when taken with the accompanying drawings in which:

FIG. 1 is a configuration schematic diagram of one example of a fashion coordination assist system in a first exemplary embodiment of the present invention;

FIG. 2 is a configuration schematic diagram of one example of a fashion coordination assist device in the first exemplary embodiment;

FIG. 3 is a flowchart illustrating one example of a coordination information providing process in the fashion coordination assist device of the first exemplary embodiment;

FIG. 4 illustrates an example of generating product attribute information in the first exemplary embodiment;

FIG. 5 illustrates an example of generating coordination information of products in the first exemplary embodiment;

FIG. 6 is one example of a relation table of “color”, “meta-information of impression”, and “detailed color” that are product information in the first exemplary embodiment;

FIG. 7A illustrates one example of a method of determining a hue of an assorted color against the base color on the side of formality by using a hue circle in the first exemplary embodiment;

FIG. 7B illustrates one example of a method of determining a hue of an assorted color against the base color on the side of casualness by using a hue circle in the first exemplary embodiment;

FIG. 8 illustrates one example of relation between a hue and a tone in the first exemplary embodiment;

FIG. 9A illustrates one example of a method of determining an accent color on the side of formality by using the hue circle in the first exemplary embodiment;

FIG. 9B illustrates one example of a method of determining an accent color on the side of casualness by using the hue circle in the first exemplary embodiment;

FIG. 10 illustrates a flow of generating a combination of products in the first exemplary embodiment;

FIG. 11 illustrates an example of classifying products into groups in the first exemplary embodiment;

FIG. 12 illustrates an example of meta-information of materials in the first exemplary embodiment;

FIG. 13 illustrates an example of selecting coordination information on the basis of trend in the first exemplary embodiment;

FIG. 14 illustrates an example of estimating a target age in coordination in the first exemplary embodiment;

FIG. 15 illustrates an example of selecting coordination by a user size in the first exemplary embodiment;

FIG. 16 illustrates an example of a formula for estimating a size of each part in the first exemplary embodiment;

FIG. 17 illustrates an example of selecting coordination information on the basis of a personal color in the first exemplary embodiment;

FIG. 18A illustrates classification into categories based on user's writing and the like in the first exemplary embodiment;

FIG. 18B illustrates classification into categories based on analysis of user's answers of questionnaires in the first exemplary embodiment;

FIG. 19 illustrates classification of user's fashion tendencies into categories in the first exemplary embodiment;

FIG. 20 is a configuration schematic diagram of one example of a server in the first exemplary embodiment; and

FIG. 21 is a configuration schematic diagram of one example of a fashion coordination assist device in a second exemplary embodiment of the present invention.

### EXEMPLARY EMBODIMENT

A detailed explanation will be given for exemplary embodiments with reference to the drawings.

### First Exemplary Embodiment

### (Fashion Coordination Assist System)

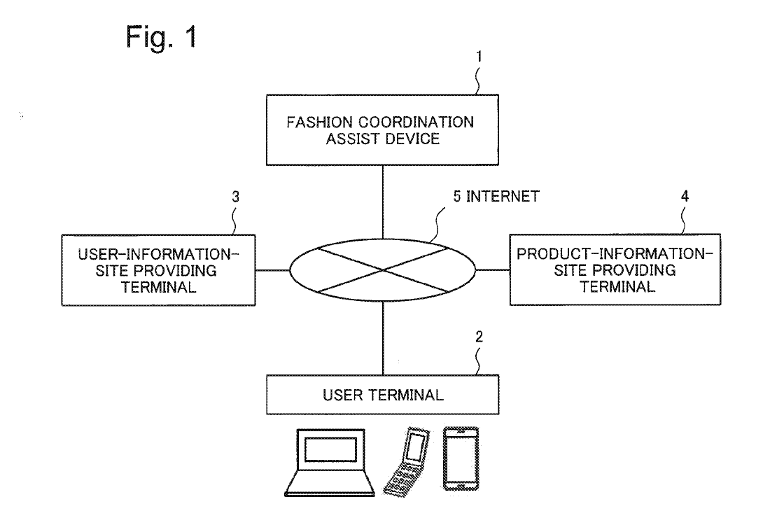

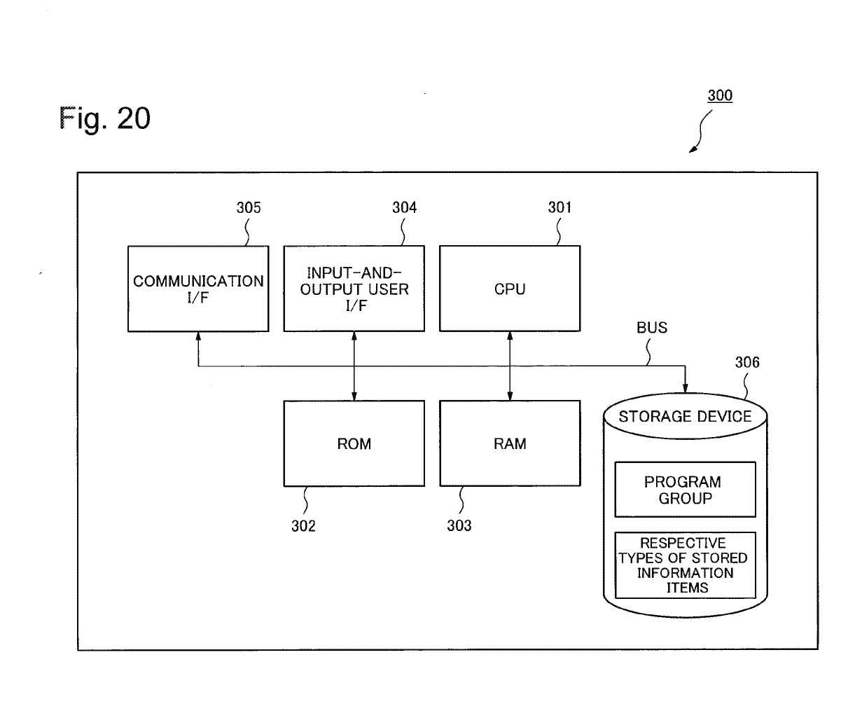

FIG. 1 is a configuration schematic diagram of one example of a fashion coordination assist system according to a first exemplary embodiment of the present invention. As illustrated in the drawing, the system of the present exemplary embodiment includes a fashion coordination assist device 1, a user terminal 2, a user-information-site providing terminal 3, and a product-information-site providing terminal 4. These can access (connect to) each other via communication lines such as the Internet 5. The fashion coordination assist device 1 according to the present exemplary embodiment is arranged in a general server 300, e.g., as illustrated in FIG. 20. The server 300 includes a central processing unit (CPU) 301, a read only memory (ROM) 302, a random access memory (RAM) 303, a communication interface (referred to as “I/F” in the following) 305 for communicating with outside devices, an input-output user I/F 304 used by a server manager or the like, and a storage device 304 that stores a group of programs and the like. The division into these elements is made for convenience of description. In actual implementation, various configurations can be expected.

As the user terminal 2, e.g., a cellular phone, a smart phone, a personal computer (PC), a tablet-type terminal, or the like may be employed.

As the user-information-site providing terminal 3, e.g., servers for user writing sites in a social networking service (SNS) site and in an online shopping site may be employed. As the product-information-site providing terminal 4, e.g., a server or the like that provides electronic commerce (EC) site operated by a product dealer may be employed. For example, the user-information-site providing terminal 3 and the product-information-site providing terminal 4 each have the same or similar hardware configuration as the server 300 illustrated in FIG. 20.

The system of the present exemplary embodiment may further include a product-information-provider terminal (not illustrated). In this case, the product-information-provider terminal and the servers can be connected to each other via the Internet. A product information obtaining unit of the above-mentioned device can obtain the product information from the product-information-provider terminal via the Internet. For example, the product-information-provider terminal has the same or similar hardware configuration as the server 300 illustrated in FIG. 20.

### (Fashion Coordination Assist Device)

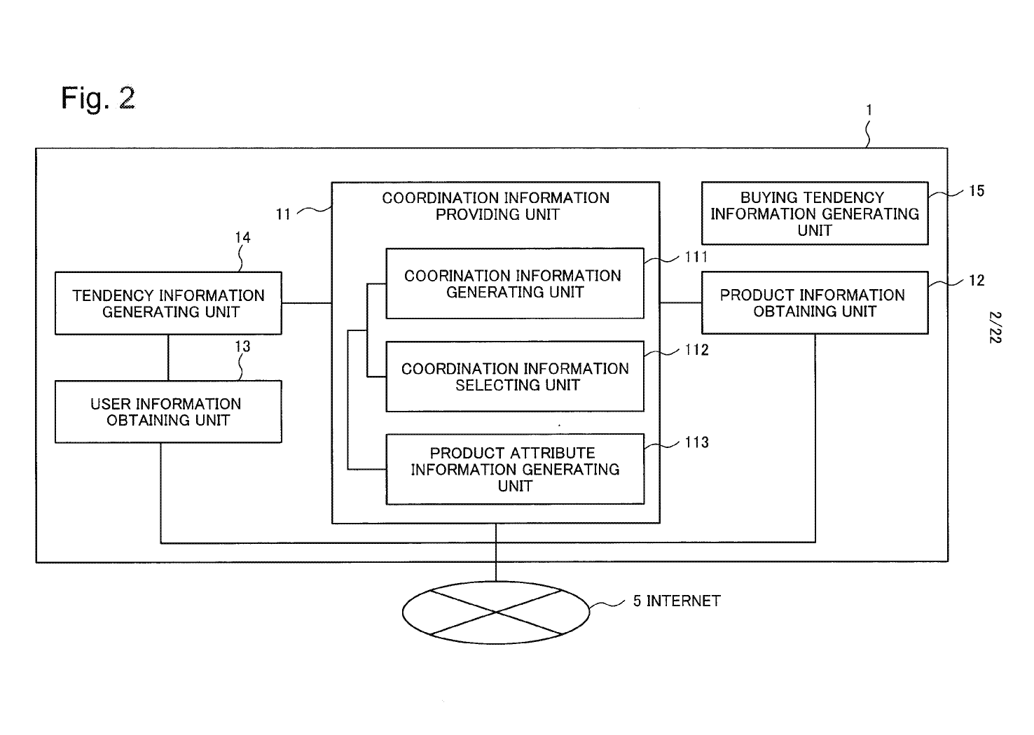

FIG. 2 is a configuration schematic diagram of one example of the fashion coordination assist device according to the present exemplary embodiment. As illustrated in the drawing, the fashion coordination assist device 1 of the present exemplary embodiment is constituted by a coordination information providing unit 11, a product information obtaining unit 12, a user information obtaining unit 13, and a tendency information generating unit 14. These elements may be configured by circuits. Alternatively, these elements may be provided as programs in a CPU 301, a ROM 302, or a storage device 306 in FIG. 20 to be embodied by operation that is appropriately performed by the CPU 301. The coordination information providing unit 11, the product information obtaining unit 12, and the user information obtaining unit 13 can be connected to the Internet 5. The product information obtaining unit 12 obtains product information existing in the Internet 5. On the basis of the product information obtained by the product information obtaining unit 12, the coordination information providing unit 11 provides, to a user, via the Internet 5, coordination information of a combination of products to be worn by a user. The user information obtaining unit 13 obtains user information existing in the Internet 5. On the basis of the user information obtained by the user information obtaining unit 13, the tendency information generating unit 14 estimates fashion tendency of a user to generate user fashion tendency information. Then, on the basis of the user fashion tendency information generated by the tendency information generating unit 14, the coordination information providing unit 11 provides the above-mentioned coordination information. These processes are features of the present exemplary embodiments.

In the fashion coordination assist device 1 of the present exemplary embodiment, the coordination information providing unit 11 includes a coordination information generating unit 111, a coordination information selecting unit 112, and a product attribute information generating unit 113.

The coordination information generating unit 111 generates a plurality of coordination information items by combinations of products on the basis of the above-mentioned product information. From a plurality of the coordination information items generated by the coordination information generating unit 111, the coordination information selecting unit 112 selects the coordination information suitable for the user. The coordination information selecting unit 112 selects the coordination information on the basis of the user fashion tendency information generated by the tendency information generating unit 14.

In the fashion coordination assist device 1 of the present exemplary embodiment, the coordination information items are generated by the coordination information generating unit 111 on the basis of combinations of attribute information about colors of a plurality of products, for example. In the fashion coordination assist device 1 of the present exemplary embodiment, the coordination information are selected by the coordination information selecting unit 112 on the basis of the above-mentioned user fashion tendency information, for example. This selection is made on the basis of at least one selected from a group including not only the user fashion tendency information, but also attribute information other than a color of a product, trend information of fashion, and attribute information of a user who receives provision of the coordination information.

In the fashion coordination assist device 1 of the present exemplary embodiment, the attribute information other than a color of a product is at least one selected from a group including a material of a product, a design of a product, and impression of a product, for example. The attribute information of a user is at least one selected from a group including an age, a size, a skin color, a hair color, and a personal color, for example. The attribute information of a user is input via the Internet 5 from the user terminal 2 to the fashion coordination assist device 1 of the present exemplary embodiment, for example.

The coordination information generating unit 111 and the coordination information selecting unit 112 generate coordination information items and select the coordination information, on the basis of product attribute information generated by the product attribute information generating unit 113. When the above-mentioned product information includes text information, the product attribute information generating unit 113 preferably generates the product attribute information from the text information by text analysis.

The following description is directed to an example of a process in which the fashion coordination assist device 1 of the present exemplary embodiment selects the coordination information on the basis of the user fashion tendency information. On the Internet 5, the fashion coordination assist device 1 previously classifies information of a plurality of users into categories for respective fashion tendencies. The fashion coordination assist device 1 determines which category among categories classified on the Internet 5 information of a user receiving coordination information belongs to. Next, the fashion tendency of the category to which the user belongs is recognized as the fashion tendency of the user receiving coordination information. On the basis of the recognized fashion tendency, the fashion coordination assist device 1 selects the coordination information. A concrete example of selecting the coordination information is described later.

The fashion coordination assist device 1 of the present exemplary embodiment further includes a buying tendency information generating unit 15 that generates buying tendency information expressing a tendency of product purchase of a user. Preferably, the buying tendency information generated by the buying tendency information generating unit 15 can be transmitted via the Internet 5 to the product-information-site providing terminal 4. This is because knowledge of the tendency of product purchase of a user can be important information on the side of a product-information-site provider at the time of considering product lineup and the like.

As the buying tendency information, for example, information such as a gender, an age, a vocation, a size, and a purchasing product type of a purchaser may be used. In the fashion coordination assist device 1 of the present exemplary embodiment, the product-information-site providing terminal 4 may be charged when the buying tendency information is provided.

### (Flow of Process by Device of the Present Exemplary Embodiment)

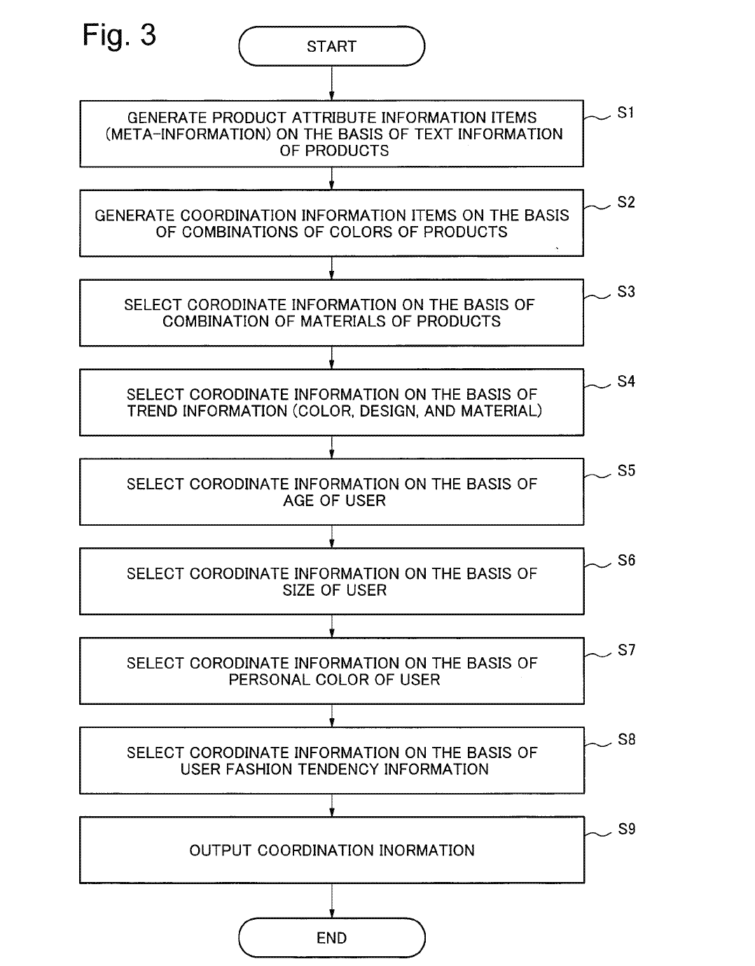

A flowchart in FIG. 3 illustrates one example of a coordination information providing process in the fashion coordination assist device 1 of the present exemplary embodiment.

First, in the fashion coordination assist device 1 of the present exemplary embodiment, the product attribute information generating unit 113 generates product attribute information (meta-information) on the basis of text information of a product (step S1). The coordination information generating unit 111 generates coordination information items on the basis of combinations of colors of products (step S2). The coordination information selecting unit 112 selects and narrows the generated coordination information items on the basis of a combination of materials of products, trend information (such as a color, a design, and a material of a product), an age of a user, a size of the user, a personal color of the user, and the user fashion tendency information (steps S3 to S8). Then, the selected coordination information items are output to end the process (step S9). The output coordination information items are transmitted via the Internet 5 to the user terminal 2 (refer to FIG. 1). The order of selecting the coordination information items are an example in FIG. 3, and is not limited to the illustrated order. Various orders can be adopted to select and narrow the coordination information items. In the following, each step illustrated in FIG. 3 is described in detail.

### (Generation of Product Attribute Information (Meta-Information))

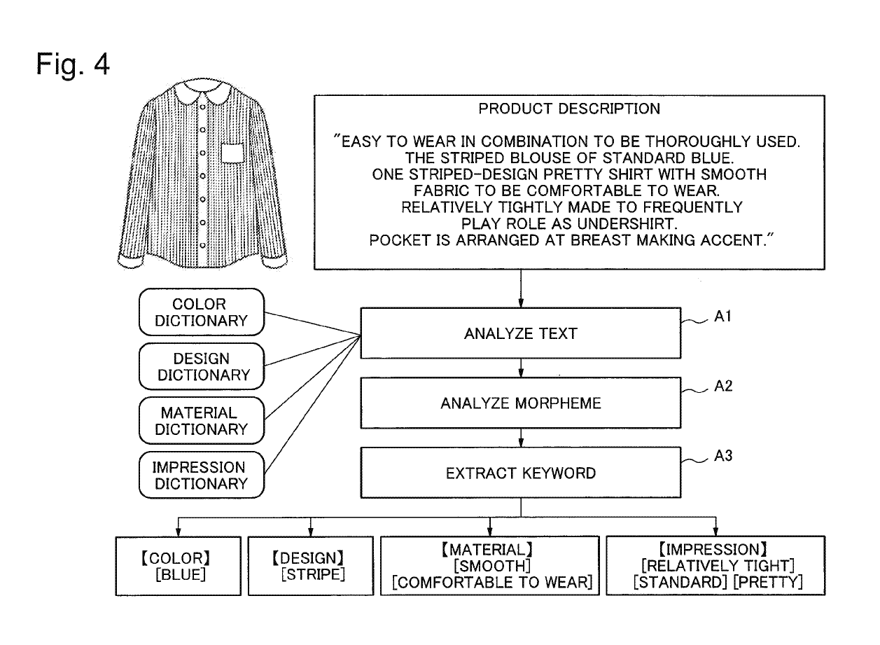

In the fashion coordination assist device 1 of the present exemplary embodiment, prior to generation of coordination information items, the product attribute information generating unit 113 generates product attribute information. An example of generation of product attribute information is described with reference to FIG. 4. As illustrated in the drawing, it is assumed that the product-information-site providing terminal 4 includes, as product description for clothes (shirt), text information: “Easy to wear in a combination to be thoroughly used. The striped blouse of standard blue. A striped-design pretty shirt with a smooth fabric to be comfortable to wear. Relatively tightly made to frequently play a role as an undershirt. A pocket is arranged at a breast making an accent”. In this case, first, at the step A1, the product attribute information generating unit 113 refers to dictionaries for respective items (e.g., a color dictionary, a design dictionary, a material dictionary, and an impression dictionary) to perform text analysis. For example, the dictionaries for the respective items are previously created from a fashion glossary available to the public on the Internet, and are periodically brushed up. The text analysis may use software of an open source such as MeCab available to the public, for example. At the step A2, after the text analysis, morphologic analysis is performed. Then, at the step A3, keyword extraction is performed to arrange one or more keywords for each item. For example, as illustrated in the drawing, from the text of the product description, one or more keywords are arranged for each item such that “blue” is arranged for the color item, “stripe” is arranged for the design item, “smooth” and “comfortable to wear” are arranged for the material item, and “relatively tightly”, “standard”, and “pretty” are arranged for the impression item. Thereby, the product attribute information (meta-information) is generated. The generated product attribute information (meta-information) is appropriately used, in accordance with necessity, in generating and selecting (narrowing) coordination information items, as described later.

### (Generation of Coordination Information Items)

The coordination information generating unit 111 generates coordination information items on the basis of combinations of colors of respective products. Generation of the coordination information items determines color arrangement in coordination in accordance with chromatics, for example.

The color arrangement is determined by divided three types of “base color”, “assorted color”, and “accent color”, for example. “Base color” is a color that is a base for entirety and that is used in approximately 60% of a surface area of a body. “Assorted color” is a color that is combined with “base color” and that is used in approximately 30% of the surface area of the body. “Accent color” is a color that becomes an accent for the entirety and that is used in 10% or less of the surface area.

Prior to determination of the color arrangement at the coordination information generating unit 111, colors are preferably defined. Definition of colors can be made (122 colors) in line with the definition of traditional color names (foreign color names) by Japanese Industrial Standards (JIS), for example. According to JIS, a hue, brightness, and saturation of each color is defined. When a color name that is not defined by JIS is used in the product information, this color name can be replaced with a similar color name. For example, “vintage navy” can be replaced with “navy”, “cream” can be replaced with “cream yellow”, and “mustard” can be replaced with “blond”. Preferably, for color replacement, a replacement table for replacing colors is previously created.

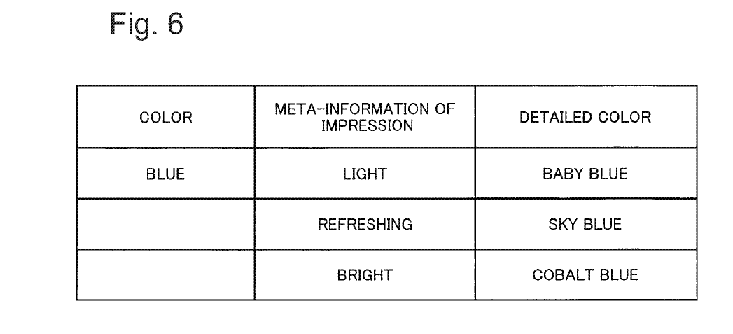

Both of “color” and “meta-information of impression” in the product information is preferably used to obtain “detailed color”. For example, when “color” is “blue”, and “meta-information of impression” are “refreshing”, “detailed color” is set as “sky blue”. When a word and a phrase related to the meta-information of impression do not exist in the product information, “color” is used without replacement. A relation table of “color”, “meta-information of impression”, and “detailed color” is preferably created. An example of the relation table is illustrated in FIG. 6. As illustrated in the drawing, when “color” is blue, and “meta-information of impression” is “light”, a detailed color is “baby blue”, when “color” is blue, and “meta-information of impression” is “refreshing”, a detailed color is “sky blue”, and when “color” is blue, and “meta-information of impression” is “bright”, a detailed color is “cobalt blue”.

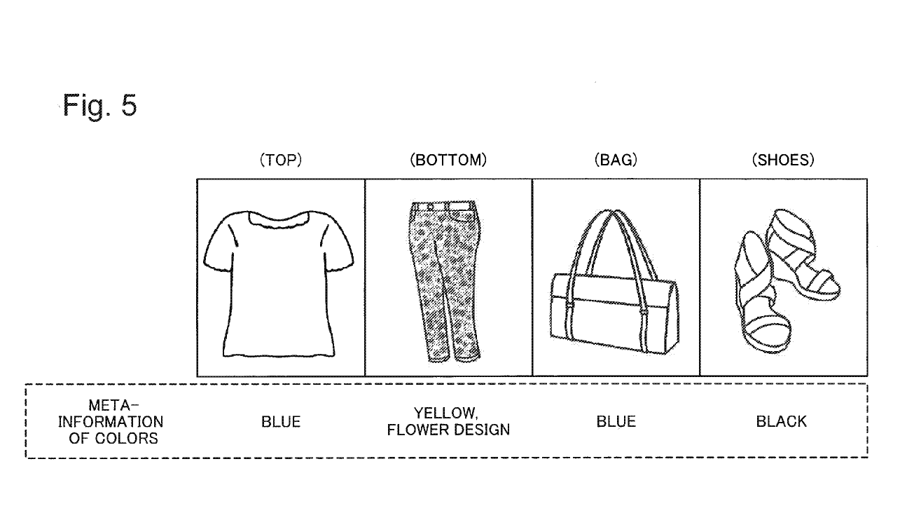

An example of generation of coordination information items of products at the coordination information generating unit 111 is described with reference to FIG. 5. Coordination illustrated in FIG. 5 is an example of a top, a bottom, a bag, and shoes. First, “colors” are determined. Initially, a base color is randomly determined as “blue”. By arrangement of colors opposite to each other, an assorted color is determined as “yellow”. Then, an accent color is determined as “black” that is an achromatic color and that is well compatible to any colors. Next, products are selected. As illustrated in FIG. 5, first, the top is selected. The top has the color meta-information that includes the base color “blue”. Next, the bottom is selected. The bottom has the color meta-information that includes the assorted color “yellow”. The user information and the like are referred to, and for example, outerwear is omitted because of summer. Next, the shoes are selected. The shoes have the color meta-information that includes the accent color “black”. Last, the bag is selected. The bag has the color meta-information that includes the base color “blue”. Thus, the coordination information of the top, the bottom, the bag, and the shoes is generated. For generating the coordination information illustrated in FIG. 5, a rule is set such that a base color or an assorted color is used in the top or the bottom. For generating the coordination information illustrated in FIG. 5, a rule is set such that an accent color is used in the bag or the shoes. A method of determining “base color”, “assorted color”, and “accent color”, and a method of combining respective products (items) are described later.

The coordination information generating unit 111 randomly determines a hue of the base color, and determines a tone by taking a degree of formality and casualness into account. For example, as a degree of formality becomes higher, a tone of the base color is limited to a tone having lower color saturation, and as a degree of casualness becomes higher, a tone of the base color is allowed to have higher color saturation.

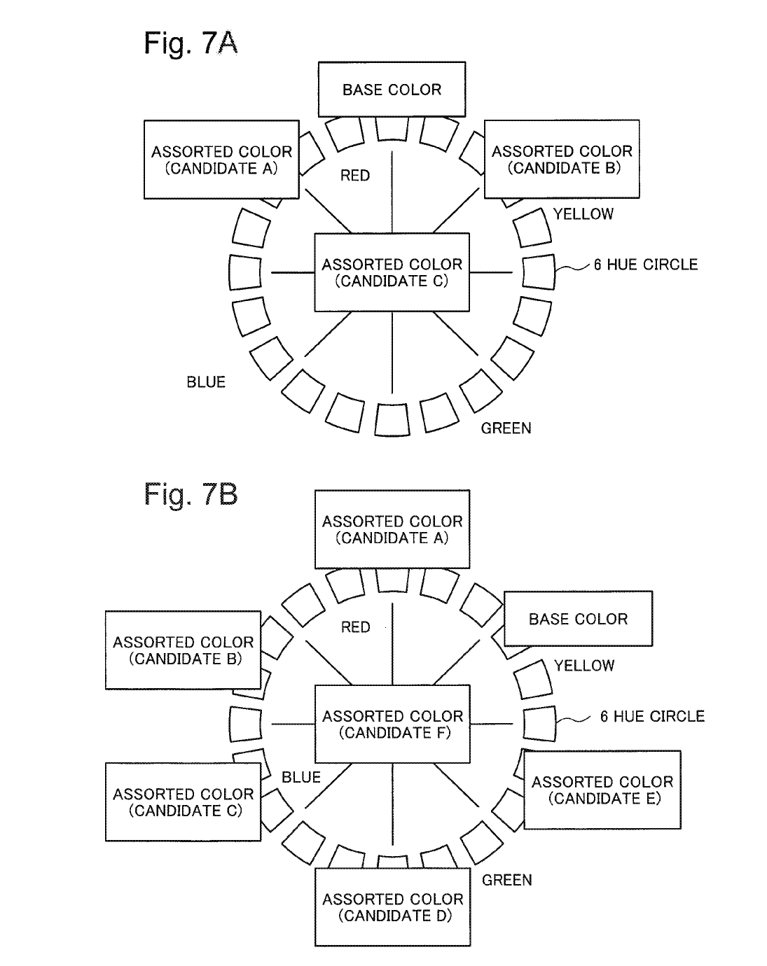

The coordination information generating unit 111 determines a hue of the assorted color by taking into account the base color and a degree of formality and casualness, for example. For example, as a degree of formality becomes higher, a hue difference between the base color and the assorted color becomes smaller, and as a degree of casualness becomes higher, the base color and the assorted color that more differ in a hue are allowed to be combined. A combination with an achromatic color is allowed regardless of a degree of formality and casualness. FIG. 7A and FIG. 7B each illustrates one example of a method in which the coordination information generating unit 111 determines a hue of the assorted color against the base color by using a hue circle 6. As illustrated in FIG. 7A, on the formal side, colors that less differ in a hue from the base color are set as assorted color candidates A and B. Meanwhile, as illustrated in FIG. 7B, on the casual side, colors that more differ in a hue from the base color are allowed to be combined so that assorted color candidates A, B, C, D, and E are set. As illustrated in FIG. 7A and FIG. 7B, an achromatic color is set as the assorted color candidate C or F for both of the formality and casualness.

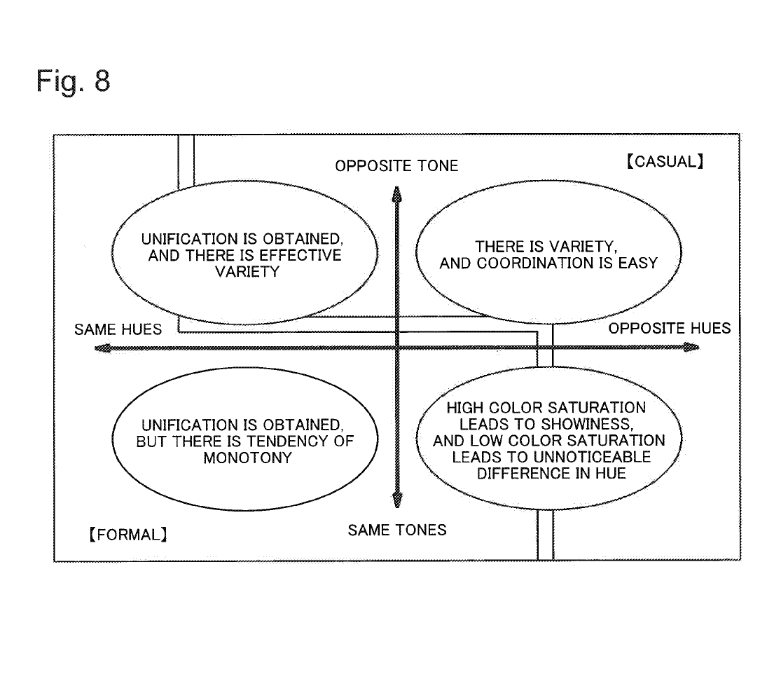

A tone (brightness and saturation) of the assorted color is determined by taking a degree of formality and casualness into account. On the formal side, for example, when a difference in a hue between the assorted color and the base color is small, a tone is arbitrary, and when the difference in a hue is large, a tone difference is set to be small. On the casual side, for example, when a difference in a hue between the assorted color and the base color is small, a tone difference is set to be large, and when the difference in a hue is large, a tone is arbitrary. FIG. 8 illustrates a table (coordination system) expressing an example of relation between a hue and a tone. As illustrated in the drawing, a horizontal axis indicates a difference in a hue (from the same hues to the opposite hues), and a vertical axis indicates a difference in a tone (from the same tones to the opposite tones). In this case, the left obliquely-downward direction (third quadrant) in the coordination system illustrated in FIG. 8 is formality, and the right obliquely-upward direction (first quadrant) in the coordination system illustrated in FIG. 8 is casualness. The four regions (quadrants) in the coordination system partitioned by the vertical axis and the horizontal axis as illustrated in FIG. 8 are described. First, the left upper region (fourth quadrant: opposite tones and same hues) represents a combination in which unification is obtained, and there is effective variety. The left lower region (third quadrant: the same tones and the same hues) represents a combination in which unification is obtained, but there is a tendency of monotony. The right upper region (first quadrant: opposite tones and opposite hues) represents a combination in which there is variety, and coordination is easy. The right lower region (second quadrant: the same tones and the opposite hues) represents a combination in which high color saturation leads to showiness, and low color saturation leads to unnoticeable difference in a hue.

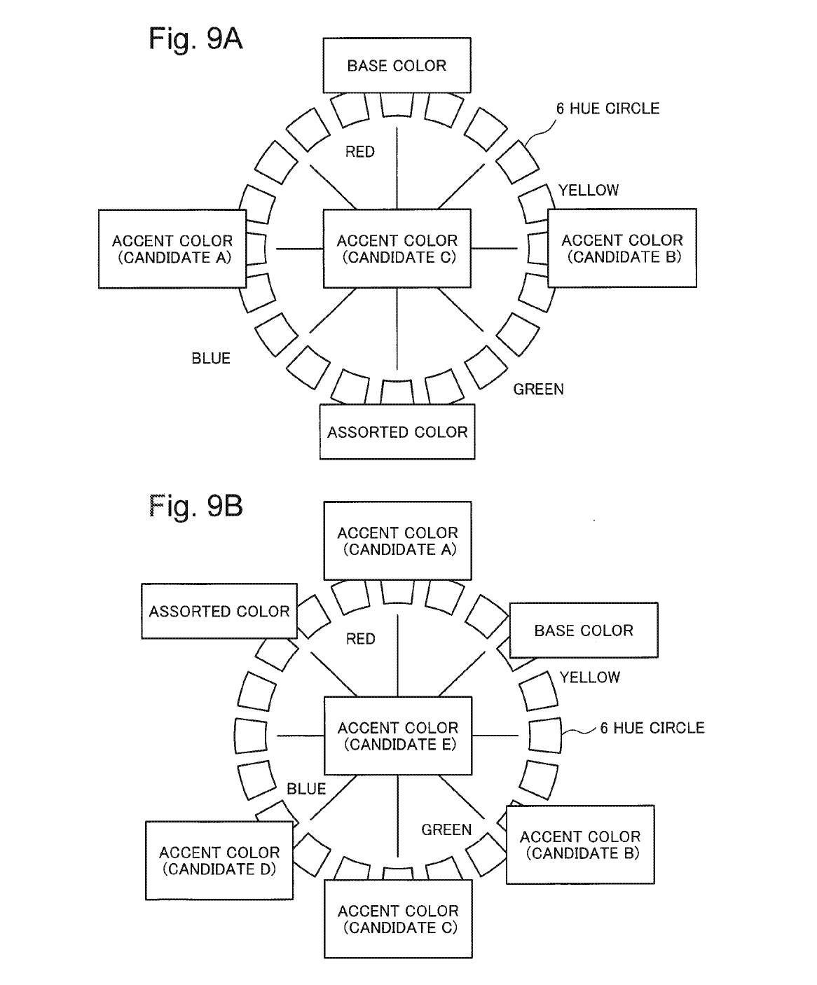

The coordination information generating unit 111 determines a hue of the accent color such that the base color, the assorted color, and the accent color form the same angle differences on the hue circle, for example. Alternatively, the coordination information generating unit 111 sets the accent color as an achromatic color. Further, a tone (brightness and saturation) of the accent color is arbitrarily set, for example. When one or both of the base color and the assorted color are achromatic, the accent color is determined in the same or similar method as for the assorted color, for example. The accent color is not set to be the same as any of the base color and the assorted color, for example. FIG. 9A and FIG. 9B each illustrate one example of a method of determining the accent color by using the hue circle 6. FIG. 9A illustrates the case on the casual side in which a difference in a hue between the base color and the assorted color is large. FIG. 9B illustrates the case on the formal side in which a difference in a hue between the base color and the assorted color is small. In any of FIG. 9A and FIG. 9B, in the hue circle 6, a hue of the accent color is determined such that the base color, the assorted color, and the accent color form the same angle differences on the hue circle, or the accent color is set as an achromatic color.

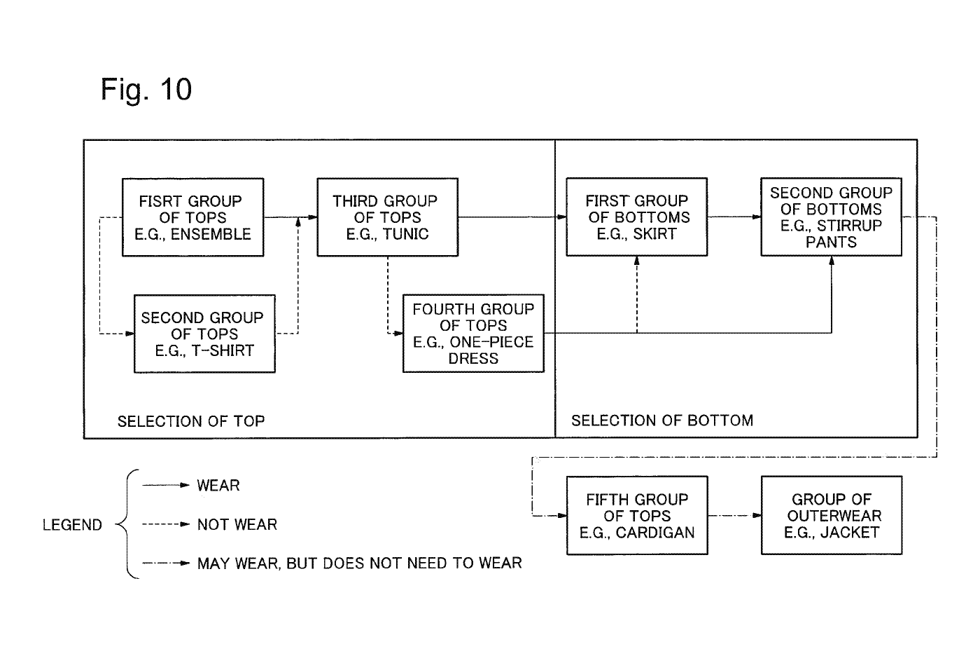

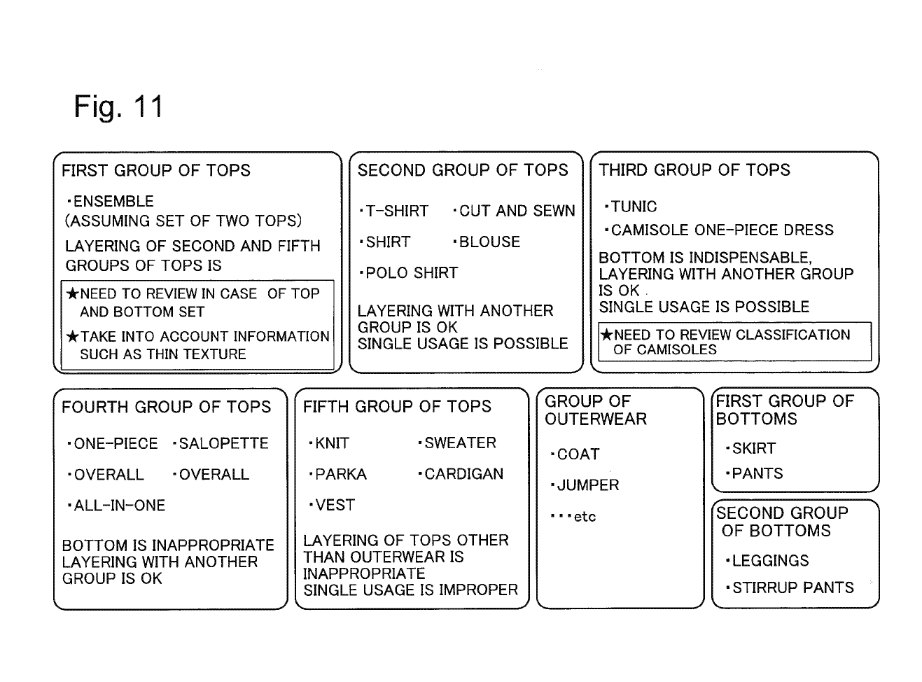

On the basis of the combination of the determined colors, the coordination information generating unit 111 generates combinations (coordination) of products (items). For example, the product-information-site providing terminal 4 for the EC site or the like sells a set of items such as an ensemble as well. For this reason, a process of combining items at the time of coordination needs to take into account wearing of several layers of clothing. In view of it, first, the coordination information generating unit 111 classifies products (items) into groups. An example of the classification is illustrated in FIG. 11. In FIG. 11, tops are classified into five groups, bottoms are classified into two groups, and one group is set for outerwear apart from tops. For generating combinations (coordination) of products (items), as described above, products (items) are classified into the groups, and determination of whether or not to wear an item is made in the order from the groups of items to wear on the inner side. As a condition for presenting whether or not to wear an item, seasons are taken into account, and several layers of clothing may be addressed. FIG. 10 illustrates a flow of generating a combination (coordination) of products (items) at the coordination information generating unit 111. As illustrated in the drawing, in this generating flow, the solid line indicates the flow of “wear”, the dotted line indicates the flow of “not to wear”, and the alternate long and short dash line indicates the flow of “not necessary to wear”. As illustrated in the drawing, the flow is started from the first group of tops such as an ensemble. In this case, the second group of tops such as a T-shirt is set for a combination not to wear, the third group of tops such as a tunic is set for a combination to wear, the third group of tops and the fourth group of tops such as a one-piece dress are set for a combination not to wear, and the third group of tops and the first group of bottoms such as a skirt are set for a combination to wear. Further, the fourth group of tops and the first group of bottoms such as a skirt are set for a combination not to wear, and the fourth group of tops and the second group of bottoms such as stirrup pants are set for a combination to wear. The first group of bottoms and the second group of bottoms are set for a combination to wear. The second group of bottoms and the fifth group of tops such as a cardigan are set for a combination that may be worn, but does not need to be worn. The fifth group of tops and the group of outerwear such as a jacket are set for a combination that may be worn, but does not need to be worn. Thus, the coordination information generating unit 111 generates combinations (coordination) of products (items), and sets the generated combinations (coordination) as coordination information items. In the generating flow in FIG. 10, when the start point from which the flow is started is the first group of tops, only the fifth group of tops is excluded from determination of whether or not to wear (not worn).

### (Selecting (Narrowing) of Coordination Information Items by Materials)

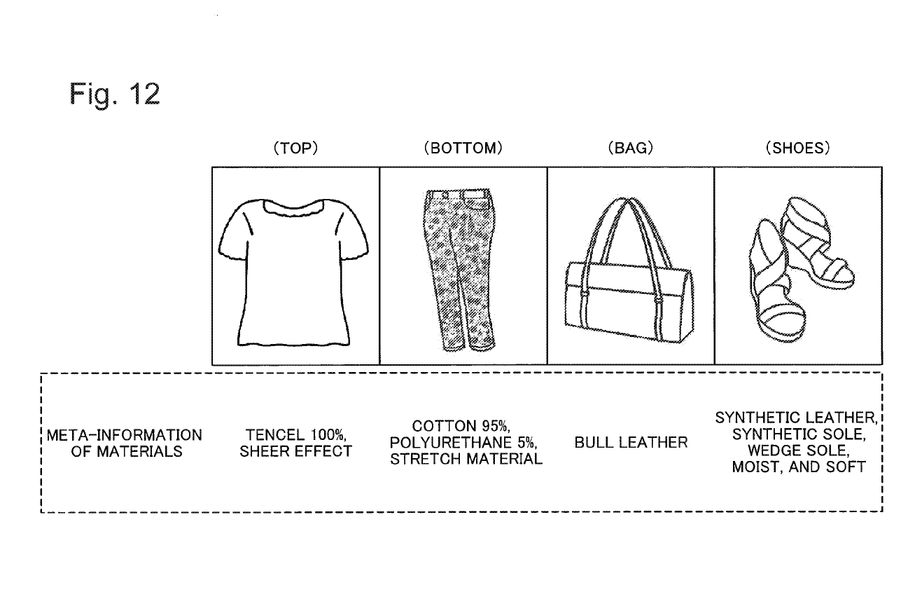

The coordination information selecting unit 112 further selects (narrows) the generated coordination information items by a combination of materials. At present, there are approximately 100 types of materials used in fashion items. For example, selection can be made in accordance with a rule in which a combination of materials of coordination (meta-information of materials) is scored, and when the scored value is smaller than a reference value, the coordination concerned is not adopted. As a method of scoring, for example, a rule-based method, a method of adopting machine learning of combination patterns of materials, or the like may be used. In the above-mentioned both methods, knowledge of a specialist such as a fashion coordinator is preferably used. FIG. 12 is a table representing an example of meta-information about materials of a top, a bottom, a bag, and shoes. As illustrated in the drawing, the meta-information about the material of the top are “Tencel 100%” and “sheer effect”, the meta-information about the material of the bottom are “cotton 95%, polyurethane 5%” and “stretch material”, the meta-information about the material of the bag are “bull leather”, and the meta-information about the material of the shoes are “synthetic leather”, “synthetic sole”, “wedge sole”, “moist”, and “smooth”. Regarding the combination of the meta-information about the materials of these products (items), the coordination information selecting unit 112 excludes the material with which combination is improper or difficult. Thereby, the coordination information selecting unit 112 performs selecting (narrowing) of the coordination information items.

### (Selecting (Narrowing) of Coordination Information Items Based on Trend)

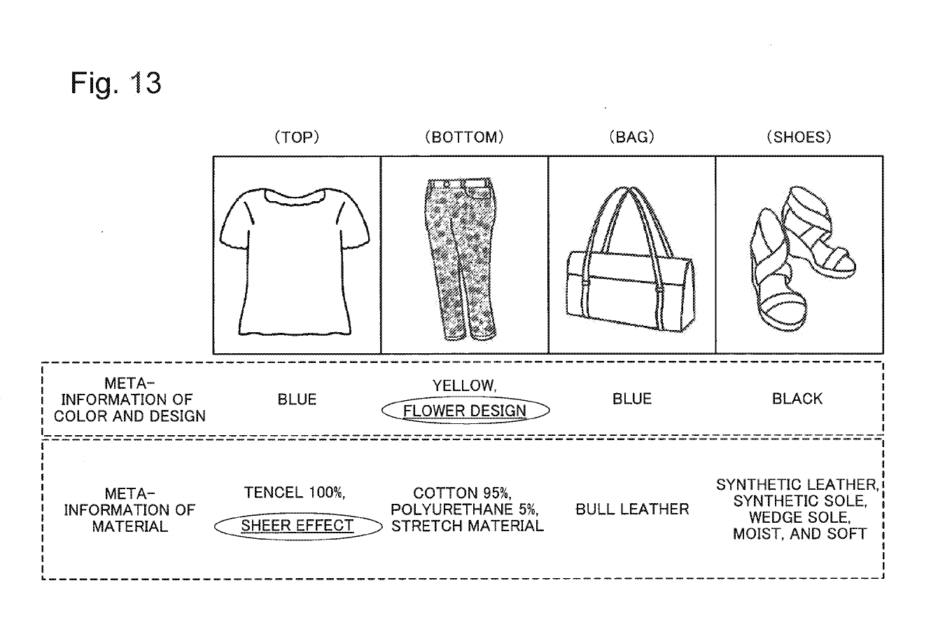

The coordination information selecting unit 112 selects (narrows) the coordination information on the basis of a trend. As a trend, for example, a trend of a color, a trend of design, a trend of a material, or the like may be considered. It is determined whether or not the coordination information includes one of a trend color, trend design, and a trend material so that the coordination information for which a result of the determination is affirmation are adopted, and the coordination information for which a result of the determination is negation are not adopted. Thereby, selecting (narrowing) of the coordination information items based on a trend is performed, for example. Preferably, the coordination information selecting unit 112 makes a database of trend information that include information from a specialist such as a fashion adviser, information from the EC site (the product-information-site providing terminal 4) of a dealer, information such as a fashion magazine on the Internet, and the like, and periodically updates the database. FIG. 13 is a table representing an example of selecting (narrowing) of the coordination information based on a trend. In the drawing, a trend color is “emerald green”, trend design is “flower design” and “geometrical design”, a trend material is “mesh”, “sheer effect”, and “gloss”. In this case, among the meta-information items of the colors, the design, and the material written in the lower part in FIG. 13, “sheer effect” of the top and “flower design” of the bottom are matched. The coordination information selecting unit 112 adopts the trend-matched products (items), and thereby selects (narrows) the coordination information.

### (Selecting (Narrowing) of Coordination Information Items Based on Age)

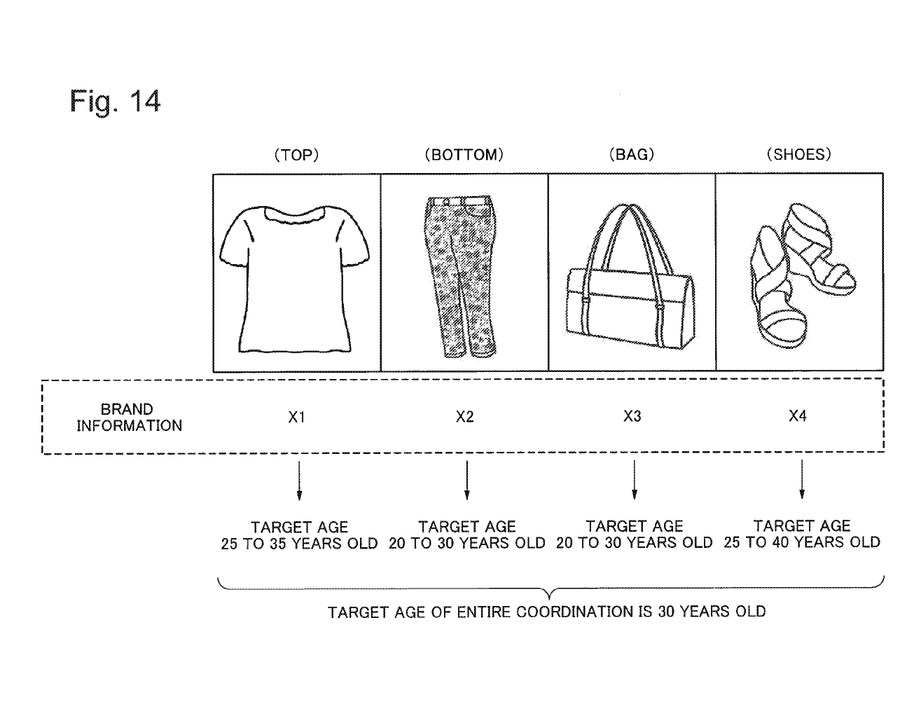

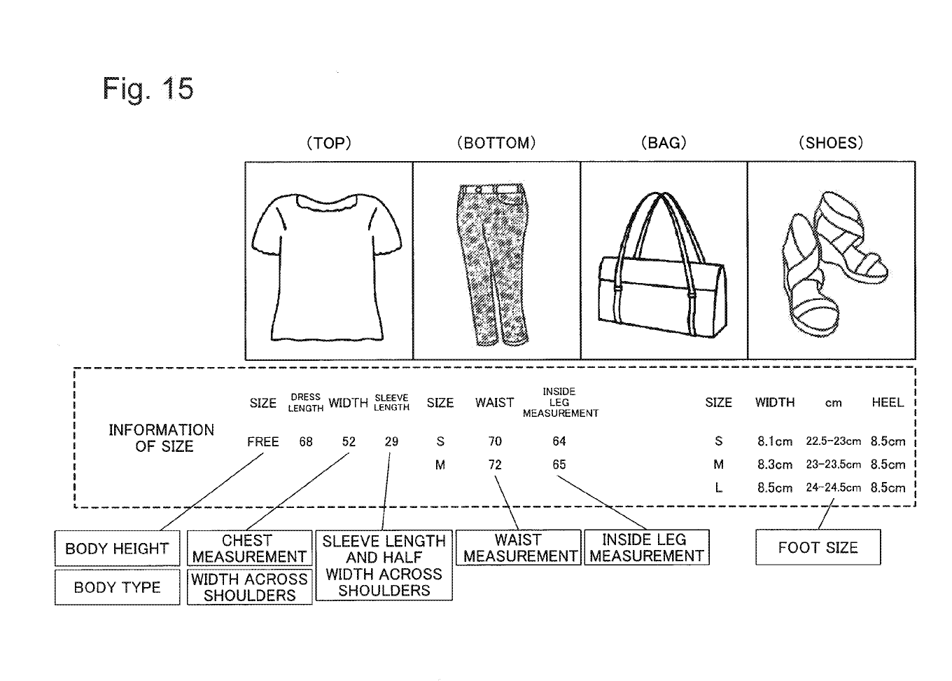

The coordination information selecting unit 112 selects (narrows) the coordination information on the basis of an age of a user. As for the selecting (narrowing) of the coordination information items based on an age, for example, the coordination information selecting unit 112 estimates a target age for coordination on the basis of brand information of each product (item), and compares the estimated target age with an age of a user. When a difference between the both ages exceeds a reference value, the coordination information selecting unit 112 does not adopt the coordination concerned, thereby the coordination information selecting unit 112 performs selecting (narrowing) of the coordination information items based on an age. The target age for coordination is estimated by, for example, determining an upper limit and a lower limit of a target age for each product (item), and averaging the upper limits and the lower limits of the target ages of the respective products (items). The upper limit and the lower limit of the target age may be determined by interviewing, for each brand of the respective products (items), a specialist such as a fashion adviser, or may be determined by obtaining information from general users by means of questionnaires, for example. Preferably, a target age for each brand may be periodically updated. FIG. 14 is a table representing an example of estimating a target age for coordination on the basis of brand information. In the drawing, a target age of a brand “X1” of a top is from 25 to 35, a target age of a brand “X2” of a bottom is from 20 to 30, a target age of a brand “X3” of a bag is from 20 to 30, and a target age of a brand “X4” of shoes is from 25 to 40. In this case, a target age for the entire coordination can be set as the value of 30 which is obtained by averaging the target ages of the respective brands. Then, the coordination information selecting unit 112 obtains a difference between the target age of 30 for the entire coordination and an age of a user. When this difference is larger than the reference value, the coordination information selecting unit 112 does not adopt the coordination concerned. In this manner, the coordination information selecting unit 112 selects (narrows) the coordination information.

### (Selecting (Narrowing) of Coordination Information Based on Size)

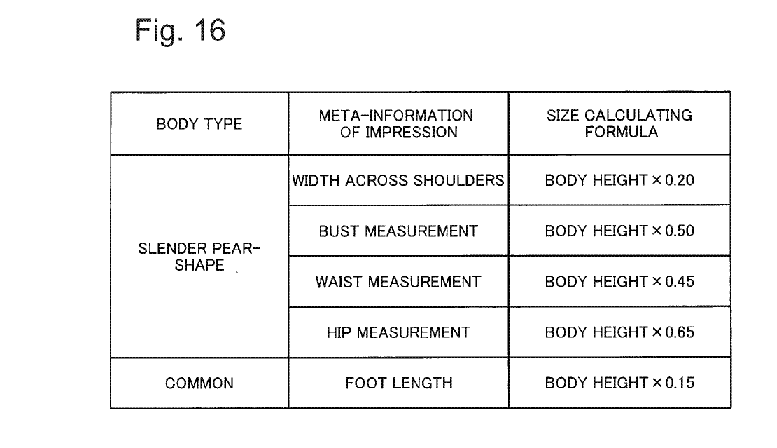

The coordination information selecting unit 112 selects (narrows) the coordination information on the basis of a size of a user obtained from the user information obtaining unit 13. As size information of a user, for example, a height, a width of shoulders, a bust measurement (a body width or a chest measurement), a waist size (a waist measurement), a hip measurement, a sleeve length (a sleeve length and half a width across shoulders), an inside leg measurement, a foot size, a body type, and the like may be used. In size comparison, sizes of each product (item) and a user are compared. For example, in the case of outerwear, widths of shoulders and bust measurements (body widths) are compared, in the case of a top, widths of shoulders and bust measurements (body widths) are compared, in the case of a bottom, waist measurements and hip measurements are compared, in the case of shoes, foot sizes are compared, and in the case of a bag, heights are compared. For each product (item), the coordination information selecting unit 112 previously determines an allowable range of a difference between a size of a user and a size of the product (item). The coordination information selecting unit 112 does not adopt coordination including a product for which the above-mentioned difference is outside the allowable range. Thereby, the coordination information selecting unit 112 selects (narrows) the coordination information. FIG. 15 is a table representing an example of selecting (narrowing) the coordination on the basis of a size of a user. In the drawing, there are respective size information of a top, a bottom, and shoes. These size information are compared with a size of a user to select (narrow) the coordination. When the user information obtaining unit 13 of the fashion coordination assist device 1 does not obtain a size of each part of a user, the size of each part is estimated on the basis of the information of a height and a body type by using a previously prepared estimating formula. An example of the estimating formulae for sizes of respective parts is represented in FIG. 16. The formulae defined in FIG. 16 calculate (estimate), from a height, sizes of respective parts, i.e., a width across shoulders, a bust measurement, a waist measurement, and a hip measurement in accordance with body type information of a slender pear-shape. In FIG. 16, a foot size is calculated (estimated) by the fixed formula that does not depend on body types.

### (Selecting (Narrowing) of Coordination Information Items Based on Personal Color)

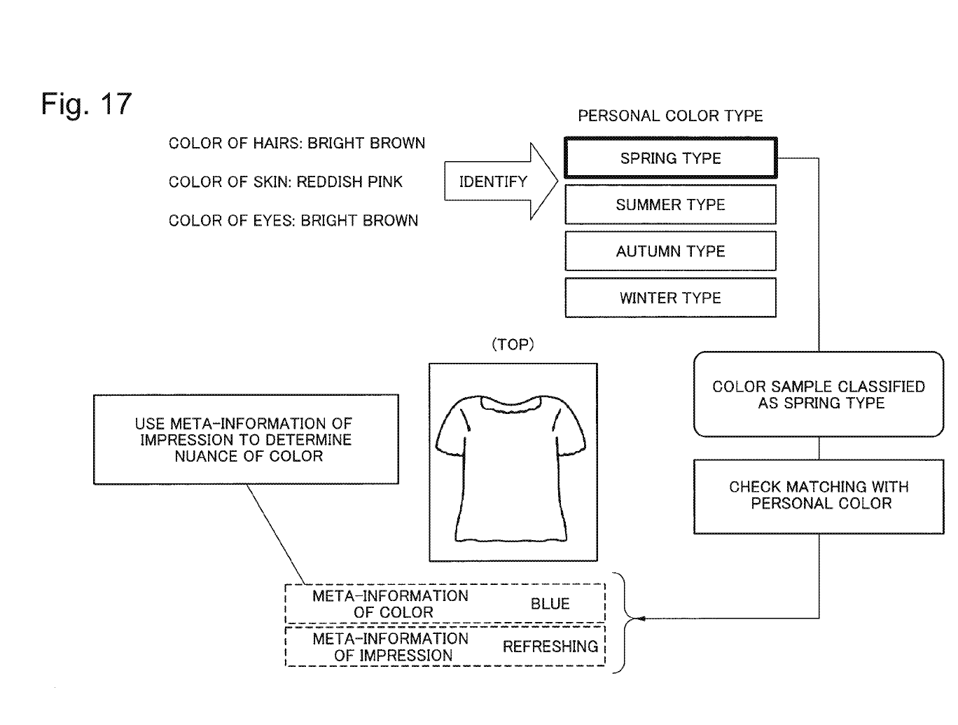

The coordination information selecting unit 112 selects (narrows) the coordination information on the basis of a personal color. The personal color means a color that suits a person concerned (does not mean a color that a person concerned likes). The personal colors are classified into four types (season colors) by body colors (colors of skin, hairs, and eyes). The four types are an autumn type, a spring type, a winter type, and a summer type. Each season color has a color feature. Colors having similar features (hue, brightness, color saturation) are combined with each other so that balanced coordination is obtained. As for selecting (narrowing) of coordination information items based on a personal color, for example, first, on the basis of personal color theory, a personal color is identified on the basis of “color of hairs”, “color of skin”, and “color of eyes” of a user. When the personal color does not match colors of a top/outerwear (comparison is performed for an item positioned near a face), the coordination concerned is not adopted, thereby, selecting (narrowing) of coordination information items based on a personal color is performed. FIG. 17 illustrates an example in which the coordination information selecting unit 112 selects (narrows) the coordination information on the basis of a personal color. In the example of the drawing, “color of hairs” is bright brown, “color of skin” is reddish pink, and “color of eyes” is bright brown. In this case, the coordination information selecting unit 112 identifies the personal color as “spring type”. The coordination information selecting unit 112 refers to color samples classified into the spring type, checks whether or not the identified personal color matches a color of a product (item), and compares the identified personal color with meta-information of a color of a top near a face to select (narrow) the coordination information. Preferably, as illustrated in the drawing, in order to determine a nuance of a color, meta-information of impression is used as well. A method of identifying a personal color is not particularly limited. For example, selection may be performed from a table of personal color types created by combinations of “color of hairs” and “color of skin”. As for the matching between a personal color and a color of product (item), for example, 122 colors defined by JIS traditional color names (foreign color names) are classified into categories related to respective personal color types. Then, by referring to the classified colors, it is checked whether or not a color of a product (e.g., outerwear or a top) matches the classified color, thereby matching a personal color and a color of product (item). In a concrete example, when a personal color of a user is the spring type, the coordination information selecting unit 112 recognizes that a color of a product is the detailed color of “sky blue” on the basis of the color meta-information of “blue” and the impression meta-information of “refreshing”. When colors of the classified category related to the spring type include “sky blue”, it can be determined that the product concerned matches the personal color of the user.

### (Selecting (Narrowing) of Coordination Information Items Based on Fashion Tendency Information of User)

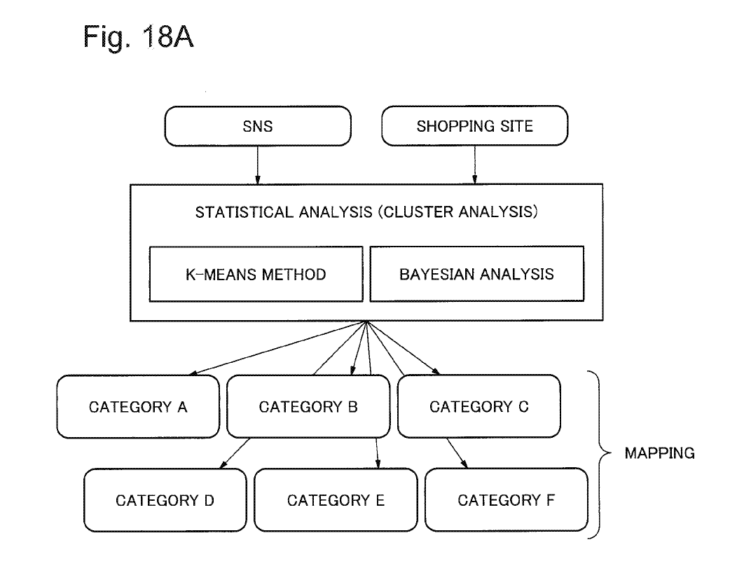

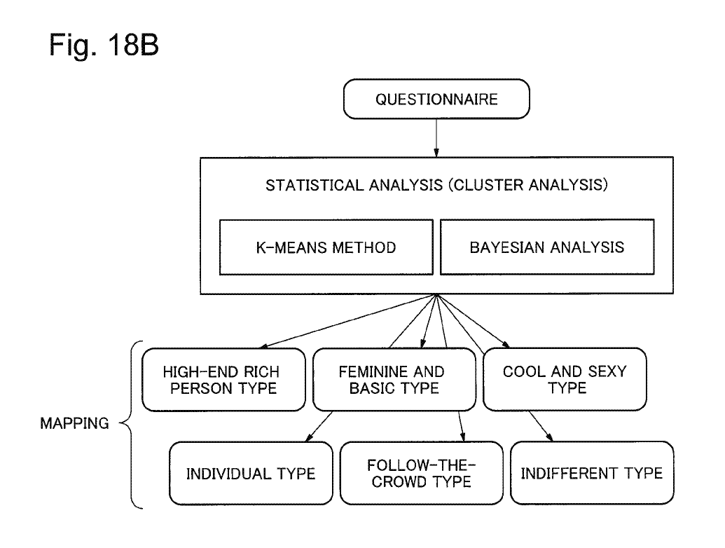

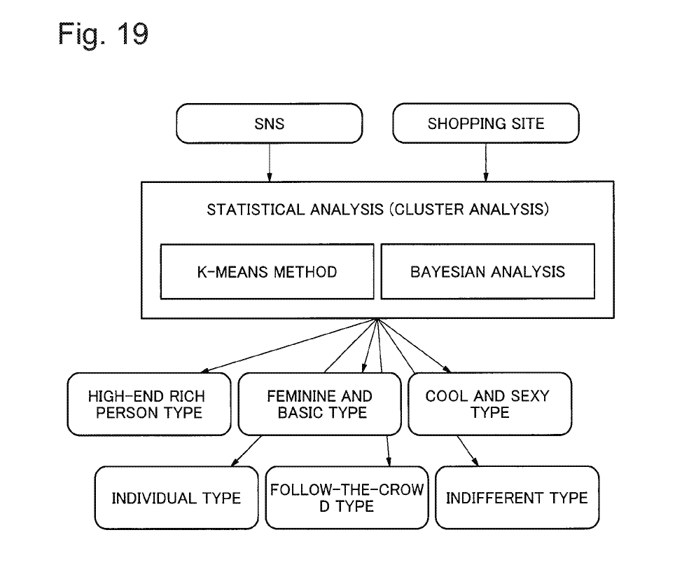

The coordination information selecting unit 112 selects (narrows) the coordination information on the basis of the fashion tendency information of a user. For example, the coordination information selecting unit 112 classifies fashion tendencies of users into categories to perform the above-mentioned selection (narrowing). The fashion tendencies of users are classified into the categories as illustrated in FIG. 18A, FIG. 18B, and FIG. 19, for example. First, as illustrated in FIG. 18A, the user information obtaining unit 13 obtains writing and a buying history of a user in an SNS site on the Internet provided by the user-information-site providing terminal 3, in a shopping site provided by the product-information-site providing terminal 4 or the like. The tendency information generating unit 14 analyzes the obtained these information items, and classifies the information items into the categories related to respective groups regardless of a fashion tendency. The analysis for the classification into the categories is performed by the K-means method, the Bayesian analysis, or the like. Meanwhile, as illustrated in FIG. 18B, monitors are gathered to analyze answers of questionnaires about fashion by, for example, the K-means method, the Bayesian analysis, or the like, and to classify the answers into the categories related to the respective fashion tendencies. In FIG. 18B, as the categories in the classification in terms of the respective fashion tendencies, there are six classified categories of “high-end rich person type” (placing a significance on a status, and being fond of brands)”, “feminine and basic type (desiring to be agreeable with anybody), “cool and sexy type (being conscious of eyes of persons of the opposite sex, and being an attention-getting type)”, “individual type (placing a significance on his or her individuality)”, “follow-the-crowd type (conforming to those around him or her, and being fond of trend)”, and “indifferent type (having a low interest in fashion)”. The tendency information generating unit 14 performs mapping of the classification into the categories in FIG. 18A and the classification into the categories in FIG. 18B. Further, as illustrated in FIG. 19, the tendency information generating unit 14 analyzes a buying history and writing of a user in an SNS site and a shopping site in the Internet by the K-means method, the Bayesian analysis, or the like. Then, the tendency information generating unit 14 performs the classification into the categories. Thereby, the tendency information generating unit 14 determines a fashion tendency of a user. Then, on the basis of the determined fashion tendency, the coordination information selecting unit 112 selects (narrows) the coordination information. In a concrete example of the selecting (narrowing), in the case of the classification into the categories in FIG. 18B, the coordination information selecting unit 112 sets priority as follows, for example. In the case of “high-end rich person type”, the selecting (narrowing) based on an age is modified to prioritize a high brand. In the case of “feminine and basic type”, the color combination is modified to prioritize a quiet color. In the case of “cool and sexy type”, the color combination is modified to prioritize a bright tone, or the narrowing based on trend is modified to put a significance on trend. In the case of “individual type”, the color combination is modified to avoid a combination of innocuous colors, or the narrowing based on a personal color is modified to places a significance on the personal color. In the case of “follow-the-crowd type”, the narrowing based on trend is modified to put a significance on trend. In the case of “indifferent type”, the color combination is modified to prioritize a combination of innocuous colors.

### Second Exemplary Embodiment

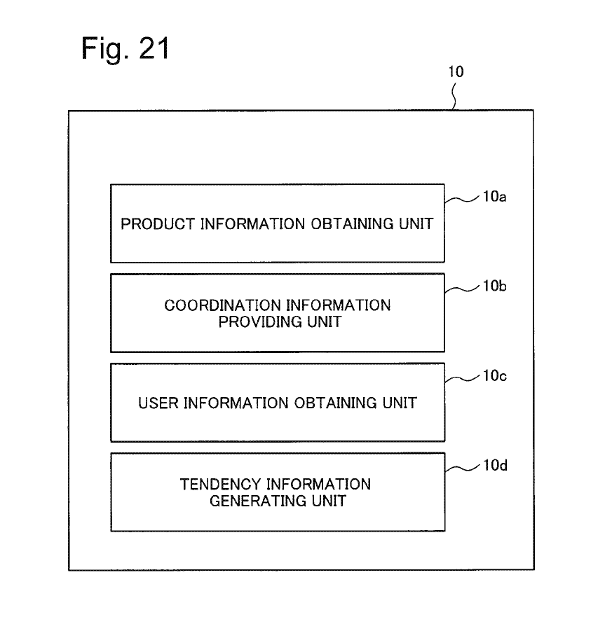

A fashion coordination assist device 10 according to a second exemplary embodiment of the present invention is described. As illustrated in FIG. 21, the fashion coordination assist device 10 includes a product information obtaining unit 10a, a coordination information providing unit 10b, a user information obtaining unit 10c, and a tendency information generating unit 10d.

The product information obtaining unit 10a obtains product information via a communication line. On the basis of the product information obtained by the product information obtaining unit, the coordination information providing unit 10b provides coordination information representing a combination of products that a user wears. On the basis of user fashion tendency information generated by the below-described tendency information generating unit 10d, the coordination information providing unit 10b provides the coordination information. The user information obtaining unit 10c obtains user information via a communication line. On the basis of the user information obtained by the user information obtaining unit 10c, the tendency information generating unit 10d estimates a fashion tendency of a user to generate tendency information that are information representing a fashion tendency of a user.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. A fashion coordination assist device comprising:
a product information obtaining unit to obtain product information via a communication line;
a coordination information providing unit to provide coordination information representing a combination of products to be worn by a user, on the basis of the product information obtained by the product information obtaining unit;
a user information obtaining unit to obtain user information via the communication line; and
a tendency information generating unit to estimate a fashion tendency of the user on the basis of the user information obtained by the user information obtaining unit, and generates tendency information representing a tendency of fashion of the user,
wherein the coordination information providing unit provides the coordination information on the basis of user fashion tendency information generated by the tendency information generating unit.

2. The fashion coordination assist device according to claim 1, wherein
the fashion coordination assist device is communicatably connected via the communication line to
a user-information-site providing terminal to provide the user information, and
a product-information-site providing terminal to provide the product information,
wherein the user information are at least one of user information registered or described in a site of a social networking service provided by the user-information-site providing terminal and information written by the user in a shopping site provided by the product-information-site providing terminal.

3. The fashion coordination assist device according to claim 1,
wherein the coordination information providing unit includes a coordination information generating unit and a coordination information selecting unit,
on the basis of the tendency information, from the product information, the coordination information generating unit generates a plurality of coordination information items regarding combinations of products to be provided to the user, and
the coordination information selecting unit selects the coordination information suitable for the user, from the plurality of coordination information items generated by the coordination information generating unit.

4. The fashion coordination assist device according to claim 3,
wherein the coordination information generating unit previously classifies a plurality of the tendency information items into categories for respective fashion tendencies, determines which category of the classified categories the user information of the user receiving the coordination information belongs to, recognizes, as the fashion tendency of the user, the fashion tendency of the category which user information belongs to, and selects the coordination information on the basis of the recognized fashion tendency.

5. The fashion coordination assist device according to claim 3,
wherein on the basis of combinations of attribute information items concerning colors of a plurality of products, the coordination information generating unit generates the coordination information items, and
the coordination information selecting unit selects the coordination information by selection based on the tendency information, on the basis of at least one information item out of attribute information other than information of colors of the products, trend information of fashion, and attribute information of the user receiving the coordination information.

6. The fashion coordination assist device according to claim 5,
wherein the attribute information other than information concerning colors of the products are at least one information item selected from a group including materials of the products, design of the products, and impression of the products, and
the attribute information of the user are at least one information item selected from a group including an age, a size, a color of skin, a color of hairs, and a personal color.

7. The fashion coordination assist device according to claim 5, further comprising a product attribute information generating unit,
wherein the product attribute information generating unit performs text analysis on text information included in the product information to generate the product attribute information.

8. A fashion coordination assist system comprising:
a user terminal used by a user; and
a server communicatably connected to the user terminal via a communication line,
wherein the server includes the fashion coordination assist device according to claim 1, and
the server transmits, via the communication line, to the user terminal, the coordination information generated by the fashion coordination assist device.

9. The fashion coordination assist system according to claim 8, further comprising a product-information-site providing terminal communicatably connected to the server via the communication line,
wherein the product information obtaining unit of the fashion coordination assist device included in the server obtains the product information from the product-information-site providing terminal.

10. The fashion coordination assist system according to claim 8,
wherein the fashion coordination assist device further includes a buying tendency information generating unit to generate buying tendency information of the user, and
the buying tendency information generated by the buying tendency information generating unit are transmitted to the product-information-site providing terminal via the communication line.

11. A fashion coordination assist method for providing coordination information of products to a user, the method comprising that an information processing device performs
obtaining product information via a communication line;
providing coordination information representing a combination of products to be worn by a user, on the basis of the obtained product information;
obtaining user information via the communication line;
estimating a fashion tendency of the user on the basis of the obtained user information to generate tendency information that represents a tendency of fashion of the user; and
providing the coordination information on the basis of the generated tendency information at the time of providing the coordination information.

12. A non-transitory recording medium that stores a program causing a computer transmitting coordination information of products to a user terminal via a communication line, to execute:
a processing to obtain product information via a communication line;
a processing to provide coordination information representing a combination of products to be worn by a user, on the basis of the obtained product information;
a processing to obtain user information via the communication line;
a processing to estimate a fashion tendency of the user on the basis of the obtained user information to generate tendency information that represents a tendency of fashion of the user; and
a processing to provide the coordination information on the basis of the generated tendency information at the process of providing the coordination information.
